(19) United States
(12) Patent Application Publication
(10) Pub. No.: US 2003/0099792 A1
(43) Pub. Date: May 29, 2003

(54) Multi-layer film and method of making same

(76) Inventors: Gunnar Andersson, Sollentuna (SE); Henrik Falken, Lidingo (SE); Jorg Haubler, Friedberg (DE); Marcus Renz, Wiesbaden (DE)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/733,079

(22) Filed: Dec. 11, 2000

Related U.S. Application Data
(60) Provisional application No. 60/174,839, filed on Jan. 7, 2000.

(30) Foreign Application Priority Data
Dec. 11, 1999 (DE) 199 59 894

(51) Int. Cl. B32B 1/02

(52) U.S. Cl. 428/35.2; 428/523; 428/516

(57) ABSTRACT

The invention relates to an autoclaveable PVC-free multi-layer film, particularly for packaging aqueous, liquid medicinal products and having at least three layers, namely an outer layer (A), an inner layer (I) and, disposed between them, a middle layer (M), each of which consists by up to 60 to 100% by weight of polypropylene materials and by up to 40% to 0% by weight of a thermoplastic elastomer, the indications by weight respectively referring to a total weight of the respective layer and which is characterized in that following hot steam sterilization at 121° C. or higher temperatures, it displays no yield measurable according to DIN EN ISO 527-1 to -3. The invention also relates to a method of producing the film and to its use as a packaging means for the accommodation of water-based parenteral fluids or fluid lipophilic emulsions.

### PRIORITY

This application claims priority to the German application No. DE 199 59 894 filed Dec. 11, 1999 and provisional U.S. patent application No. 60/174,839 filed Jan. 7, 2000.

### FIELD OF THE INVENTION

The present invention relates generally to an autoclaveable PVC-free multi-layer film, particularly for the packaging of fluid medicinal products, the film comprising at least three layers, namely an outer layer (A), and inner layer (I) and, between them, a middle layer (M), each of which consists of up to 60 to 100% by weight in relation to the total weight of the respective layer, of polypropylene materials and by up to 40 to 0% by weight of a thermoplastic elastomer preferably from the group of styrene block copolymers. More particularly, the present invention relates to a method of producing such multi-layer films and to the use of such multi-layer films in accordance with the invention.

### BACKGROUND AND SUMMARY OF THE INVENTION

Multi-layer or multi-ply films for the packaging of materials, particularly of medicinal fluids or solutions such as cooking salt solutions, amino acid solutions, lipophilic emulsions, dialysis solutions, blood substitute solutions, blood and the like, are known.

Basically, multi-layer films, and the packaging obtained from them, such as bags or similar containers, are supposed to satisfy certain requirements. They must have a high level of flexibility so that filled bags can be completely emptied by gravity alone. They are supposed to have a very good transparency, possibly also a low water vapor permeability, should be physiologically safe and mechanically stable. They must be autoclaveable and capable of being sterilized, possibly even above 121° C., and finally it must be possible to seal them with permanently heated tools, pulse-welding and/or ultrasound.

The films do not necessarily have to be impervious to oxygen. For applications in which a highly effective oxygen barrier is important, a secondary packaging means may if necessary be used which has an effective oxygen barrier and can enclose the inner film packaging. If an oxygen trap is present between the inner film packaging and the secondary film packaging, it may be preferable for oxygen to be capable of passing through the film of the inner packaging. In this way, there is no difficulty with eliminating the residual oxygen from a sensitive packaged substance during storage.

For some applications, it may be advantageous to be able to use simple means (sealing temperature, sealing time and sealing pressure) to check the strength of the weld. This makes it possible to produce particularly peelable and/or permanent welded joints with one and the same film material and without any further aids. Furthermore, it may be advantageous if the outer layer of the film can be easily and permanently printed with conventional pigments in order in this to provide the user with important information.

In this respect, and inter alia, the outer film is intended to avoid the migration of pigments into the interior of the package. Suitable materials for the outer layers having these properties are, inter alia, in the group of the polyesters, particularly cycloaliphatic polyesters and their copolymers. Examples of this type of multi-layer films can be found in U.S. Pat. No. 4,803,102 OR U.S. Pat. No. 4,643,926.

U.S. Pat. No. 4,772,497 discloses multi-layer films comprising at least two layers and intended for packaging medicinal solutions. One layer consists of polyester, polypropylene or a mixture of polypropylene and anelastomer. The second layer consists of a mixture of polypropylene and an elastomer. A possible third layer consists of polypropylene or polyethylene. The films disclosed contain either more than 90% by weight of elastomer or polyester or both.

Although the use of polyester materials makes it possible to obtain mechanically usable films, properties such as recyclability and therefore the use of environmentally friendly materials are becoming increasingly important.

In fact, the avoidance of raw materials such as PVC which involves the problems associated with softeners, or polyester materials, which make recycling difficult by virtue of inadequate grade purity, has led to the development of more or less suitable polyolefin films. Polyolefins can be classified as materials which come closer to chemically inert competitively priced environmentally friendly and free from questionable additives which are capable of migration. Many of the so-called polyolefin films do however require a number of expensive or which are difficult to recycle additives in order to maintain the aforementioned requirements. To a certain extent, these additives must be added in such an amount that one can no longer speak of a polyolefin film. Other polyolefin films satisfy only the minimum requirements in one or other respect so that for example the mechanical properties of the films, the visual properties and/or the production characteristics for bags (sealing properties, speed of production and the like) require improvement.

Polyethylene materials and films based on or containing them are frequently too soft or are not sufficiently temperature resistant. Polypropylene materials are frequently brittle and less flexible.

U.S. Pat. No. 4,532,189 relates to a multi-layer polyolefin film. Inter alia, it discloses a three-layer construction with a core layer which consists substantially of linear, low density polyethylene and two outer layers which consist substantially of a mixture of 80% by weight of an ethylene propylene copolymer and 20% by weight of a propylene homopolymer. The LLDPE used in the core layer can be replaced by an LMDPE. Both materials are not very stable. From this arises the suitability of the multi-layer film described for use as a shrink-wrap packaging. Certainly, the lack of temperature stability prohibits its use for packaging medicinal goods since the materials have to be able to withstand hot steam sterilization at temperatures of 121° C. or more.

U.S. Pat. No. 4,643,926 discloses flexible three-layer films for the packaging of medicinal solutions and parenteralia, the sealing layer consisting of ethylene propylene copolymer or flexible copolyester, one or more inner layers comprising elastomeric polymers and an outer layer of ethylene propylene copolymer or a flexible copolymer. Films according to U.S. Pat. No. 4,643,926 and packaging made therefrom such as bags or the like have outstanding mechanical characteristics. In accordance with the current state of the art, certainly, for the disclosed combinations of materials used in the layers, the presence of at least one bonding layer is needed. Viable examples are an ethylene methacrylate copolymer (EMA) or an ethylene vinyl acetate copolymer (EVA), but this in turn has the disadvantage that the film cannot be sterilized with heat without high energy irradiation vulcanization. Finally, the choice of materials leads to the conclusion that the films are not readily disposable.

U.S. Pat. No. 4,210,686 refers to multi-layer flexible synthetic plastics films which can be treated in the autoclave, and also bags made therefrom. The film comprises at least one first layer which consists of a blend of 30 to 90% by weight of a rubber-like copolymer with olefinic and polystyrene blocks and 10 to 70% by weight of a poleolefin with a temperature above 120° C. and a second layer consisting of a polyolefin which is semi-crystalline in terms of having a low steam permeability.

Known from U.S. Pat. No. 4,778,697 and U.S. Pat. No. 5,071,686, are multi-layer films with for example three layers. In some layers of the film, an elastomer or an ethylene-based copolymer is blended with polypropylene and in other layers with polyethylene. A plurality of examples of film structure are disclosed but they all comprise polyethylene in its broadest sense, whether as HDPE or as ethylene-based copolymer. From the mechanical parameters indicated in the publications, it is quite evident that only a few combinations admit of sufficient mechanical properties in order for example to withstand a drop test of the sterilized and filled bag. The very compositions involved, however, are characterized by a high proportion of HDPE in the middle layer (70 or 80% by weight). By virtue of the high HDPE content of the middle layer, behavior typical of polypropylene is disadvantageous, i.e., a measurable yield of the sterilized film can be anticipated. The first layer is thicker (60%) than the second layer (20%)and the third layer (20%).

WO 98/36905 is concerned with co-extruded multi-layer films for sterilizable containers for liquids. WO 98/36095 shows that at least a five-layer construction is needed to obtain a film with a balanced spectrum of properties. The outer layer is a polypropylene, possibly with a small amount of ethylene or alpha-olefin; the inner layer is a polyethylene with possibly small alpha-olefin fractions; the intermediate layer is of complex structure and consists of a plurality of layers, namely at least three layers, the complex intermediate layers as a whole consisting of polyolefins and the fraction of ethylene units increasing from the outer layers inwards, whereas the softening temperature of the materials of the layers decreases in the aforementioned direction. The examples taken from WO 98/36905 support the fact that the inner layer which consists of LLDPE is thicker than the outer and thicker than the total of the complex intermediate layers. Thus, LLDPE becomes the determinative material in the film. However, LLDPE is a material which with regard to its melting behavior, has a rather defined melting temperature whereas polypropylene materials have a softening range. If LLDPE is used in the sealing layer, then it is a drawback that seals of different thickness cannot be made. The lack of a definite softening interval in the case of polypropylene materials, however, is only possible by varying the time or temperature of sealing. LLDPE inner layers are therefore disadvantageous. Furthermore, also the production of an at least five layer structure must not be regarded as being particularly advantageous. Preference should go to a structure which can meet all the requirements with only three layers. Finally, the composition such as is disclosed in the examples in WO 98/36905 is susceptible to delamination. The forces for delamination in WO 98/36905 are indeed greater than in the comparative examples, but one should be seeking a film which does not suffer delamination at all.

U.S. Pat. No. 4,961,495 refers to containers made from polyolefins. It discloses sealable two-layer films in which each of the layers represents a blend of PP and LLDPE or PP, LDPE and PE. In addition, co-extruded films are also described which comprise an inner layer of LDPE and PP as well as an outer layer of LLPDE. Also HDPE can be used. By reason of the use of HDPE, LDPE and LLDPE in the individual layers of the material, it must be assumed that the films may in any even be opaque. Additionally, a dominant use of PE materials can present problems where autoclave treatment is concerned. Finally, the sealing times indicated in the examples, in the range from up to 10 seconds or more seem to be relatively long, in fact prohibitive for industrial production.

According to U.S. Pat. No. 5,478,617, multi-layer films for sterilizable containers for medicinal applications have an outer layer containing a linear ethylene alpha-olefin copolymer, an intermediate layer containing linear ethylene alpha-olefin copolymer and an inner layer of polypropylene with linear ethylene alpha-olefin copolymer. All layers contain a predetermined amount of HDPE. In the examples, LLDPEs and isotactic PPs are used along with HDPE. Although the film is said to be transparent, flexible and autoclaveable and furthermore is supposed to allow the manufacture of peelable welded seams, it has drawbacks mainly due to the choice of materials. For example, LLDPEs and isotactic PPs display the typical mechanical weaknesses known for polypropylenes. In particular, films made of such materials will probably not passed a drop test. In addition, the used of HPDE leads us to think rather more of an “opaque” film than a film of high transparency, at least after autoclave treatment of the film or of the bag consisting of it.

U.S. Pat. No. 4,892,604 describes sterilizable synthetic containers for medical purposes and consisting of a thin multi-layer film. The first layer of film is the inner layer which is in contact with the medical substance. It is of polyethylene vinyl acetate (EVA) which is free of plasticising agents. The second layer has a higher melting temperature than the first and consists for example of HDPE. The inner EVA layer must be cross-linked by irradiation for the container to be used.

PVC-free multi-layer film structures are also known from U.S. Pat. No. 5,782,269. They comprise an outer layer, a supporting layer and at least one middle layer disposed between them, the outer and supporting layers comprising polymers the softening temperature of which, according to Vicat, are above about 121° C., the middle layer comprising polymers the softening temperatures of which are below about 70° C. Preferably, the Vicat temperatures refer not only to polymers which are part of the individual layers but to the material of the respective layer as a whole. The film described is usually augmented by a sealing layer so that, all in all, the result is a four-, six-, etc., layer structure. At first sight, it is obvious that all layers may comprise PE types. As soon as too much PE is contained in the he individual layers, however, an unfavorable tension-elongation behavior with marked yield becomes more and more probable. The rubber-like middle layer (less than 70° C.) is supposed to provide flexibility. In the middle layer, this is achieved by SEBS and the use of similar materials. However, in the sterilized condition, the film still shows measurable yield and therefore has the mechanical drawbacks which this involves.

With regard to the materials to be used, the state of the art, shows an increasing trend towards the use of polypropylene materials. Possible causes for this may, as already mentioned, be seen to lie in the fact that the softening ranges and melting points of polyethylenes are frequently inadequate for hot steam sterilization. Furthermore, many polypropylenes have more favorable barrier properties with regard to steam when compared with polyethylenes. Finally, one also has to take into account the more favorable visual properties of polypropylenes. In practice, one can try to diminish the drawbacks of polypropylene by copolymerization of propylene with other monomers or by the use of a blend of polypropylene and other polymers. Hitherto, this procedure has not however, led to the desired results, namely a soft and flexible material with the highest level of mechanical workability and extreme dynamic and static loading capacity.

Multi-layer films, methods of producing them and their use have become known from. Where these multi-layer films are concerned, they comprise a polymer outer layer, polymer middle layer and heat-sealable polymer inner layer with at least one connecting layer of a polypropylene compound and/or blend consisting of polypropylene homo- and/or copolymer and at least one thermoplastic elastomer and/or polyisobutylene and an inner layer of a polypropylene compound consisting of a polypropylene homo- and/or copolymer with at least one thermoplastic elastomer. An example film comprises an outer layer (15 μm) of PP homopolymer, a connecting layer (95 μm) of PP compound, namely PP homopolymer with SEBS and TPE-S and plasticiser, as well as an inner layer (40 μm) of PP homopolymer and SEBS as TPE-S. Although U.S. Pat. No. 6,127,043 provides no teaching with regard to the amount of SEBS in the middle layer and also in the inner layer, it would however appear that the proportion has to be relatively high since the materials of the connecting layer and of the inner layer, CAWITON MED PR 3663/or CAWITON MED PR 3530, used as the compound, have relatively high proportions of SEBS. It is true that the use of SEBS is terms of flexibility and mechanical parameters (drop test and sleeve test), but SEBS compounds are relatively preferred. Furthermore, the highest possible grade purity, with regard to the synthetic plastics used, would be expedient for improved recycling of the materials. In addition, the use of plasticizing agents is obviously essential.

EP-A-0 564 206 discloses medical containers of a multi-layer construction. It proposes a three-layer structure, the outer and inner layers being made from at least one crystalline polyolefin while the intermediate layer is composed of at least one crystalline polyolefin and an amorphous polyolefin. Apart from the fact that the containers described, due to the use of crystalline polyolefins in the inner and outer layers, do not have the transparency which is currently regarded as standard (transparency greater than 92-96%—in fact some of the sample films could have been described as opaque and their transparency being only improved to an adequate degree by the addition of hydrated petroleum resins), the structure displayed is also disadvantageous for other reasons. In the Examples, exclusively isotactic propylene homo- and copolymers as well as isotactic butylene homopolymers are used as the crystalline polyolefins. However, crystalline polypropylenes and polybutylenes have an increased tendency towards typical polypropylene behavior in so far as their mechanical properties are concerned. In particular, the said materials usually have a relatively high elasticity modulus as well as a yield in the tension-elongation test. Thus, bags filled with liquid would probably not be able to withstand being dropped from a height of 2 m without suffering damage. Furthermore, bags filled with cooking salt solution, in accordance with EP-A 0 564 206, following hot steam sterilization treatment only exhibit an appearance which the disclosure describes as being “not substantially deteriorated”. Consequently, one can conclude that there is a negative change following hot steam sterilization.

Inter alia, the vast number of films described in the state of the art alone provides evidence that the ideal film for manufacturing packagings for aqueous or oily medical solutions, preferably for water-based solutions, does not so far appear to have been found. All the known films, particularly also those which have actually reached marketable maturity—as illustrated above—suffer from one unacceptable feature or another. If PVC is to be avoided by virtue of its softener problems and polyester and polyamides by virtue of an unsatisfactory recyclability, then according to the state of the art, only films based on polyolefin materials are left. A predominant use of polyethylene materials can cause problems in terms of hot steam sterilization. The temperatures during this process may start from and be markedly above the prescribed 121° C., for example 125° C. or even higher. Where such products are concerned, however, there is for polyethylene-based materials the problem of a possibly too low melting point. Transparency, sealing-tightness and mechanical behavior of the film can be altered to the point of uselessness.

Polypropylene-based materials generally have markedly higher melting temperatures than PE. However, PP-based materials represent problems with regard to mechanical properties. In addition to various pharmaceutical and optical demands of films and packaging made from them, such as bags and the like, for example so-called intravenous bags, films must also be capable of coping with quite specific and differing mechanical loading in order to meet the (mechanical) product demands imposed on the bags.

Two requirements of products such as the intravenous bag are particularly exacting from the point of view of a plastic film. On the one hand, a filled bag must be able to withstand being dropped from a height of 2 m without suffering any damage. This is an extremely dynamic loading on the bag film. On the other, a filled bag must also be able to withstand a so-called “pressure sleeve test” without suffering damage. This involves a permanent pressure loading on a filled bag to which a sleeve is applied. This extreme loading must be regarded as static, in contrast to the dynamic dropping test. Initially, both criteria contradict per se the properties of a single synthetic plastic material and so far they have not been satisfactorily fulfilled even by composite films consisting exclusively of polyolefin based and preferably polypropylene-based materials.

In view of the state of the art mentioned and discussed herein, it is nevertheless a problem underlying the invention to indicate a multi-layer film for the packaging of liquid medical products which is substantially based on polyolefin materials and which makes it possible to produce packagings which are as far as possible resistant to both dynamic loading and also to static, lasting loading.

As far as possible, the films according to the invention are supposed to allow statically and dynamically more stable packaging than known films or composite films based on polypropylene materials.

As far a possible, the new films should also be statically and dynamically at least as loadable as known films such as for example films comprising polyesters, polyamides or polyvinyl chlorides and which are not based on polyolefin materials.

The novel films should also continue to display excellent to good mechanical properties even at temperatures lower than room temperatures, e.g., around 0° C. These include inter alia high flexibility at low temperatures, minimal low temperature brittleness and a high impact strength at the aforesaid low temperatures.

Preferably, the novel multi-layer films ought to have as few layers as possible so that it is possible to produce them as easily and as inexpensively as possible.

Furthermore, the multi-layer films according to the invention should be as pure as possible and should ideally be based on polypropylene materials with the smallest possible proportions of other monomer units.

Furthermore, the materials of the individual layers ought to consist of the fewest number of individual substances. In the event a blend or compound of polymers for a layer, then the blend should comprise the purest polymer or copolymer types.

The new film should have high transparency. It ought to be autoclaveable and be able to withstand hot steam sterilization even at temperatures of 120° C. or more without damage, i.e., with no disadvantageous changes of transparency and flexibility. For example, the thermal treatment should make it possible to minimize or preferably exclude any chance of the film crystallizing or suffering any other surface damage such as discoloration, whitening or opacity.

Finally, the film should be completely safe from a pharmaceutical and medical points of view. This also includes that it should contain no additives which might appear to present a problem. In particular, the new film should show no tendency for additives to migrate from the film into the products stored therein, even after long storage times and even when the products are lipophilic liquids.

In addition, it is an object of the invention to provide a printable film which can be easily and lastingly printed with conventional pigments and methods without the pigments or dyestuffs coming in contact with the goods stored.

Furthermore, the film according to the invention should allow the making of welded joints which are as far as possible optionally peelable or non-peelable.

The film according to the invention should also allow monitoring of the strength of the weld by simple means (sealing temperature and sealing time). In this regard, it should also be possible to produce from the film according to the invention containers which have both permanent sealing seams as well as seals which can be torn open.

In particular, it should be possible for the film to be sealed with permanently heated tools or pulse-welded.

This novel film should also be weldable without the use of protective coverings of Teflon, silicon or the like. Such protective coverings have to be frequently replaced in the past. Furthermore, the new film should have a sufficiently large processing time. Part of this is that even at low temperature during welding, it should be possible to achieve sufficient strength of the weld. The processing time is also of great importance above all where the manufacture of peelable seams is concerned.

In addition, the new film should permit the production of completely collapsible bags or pouches.

Finally, packaging made from the film according to the invention ought to be entirely recyclable, possibly without down cycling, i.e., as far as possible, few materials should be used which are not environmentally friendly.

Furthermore, the films according to the invention should also have a low steam permeability. Just as they should have clarity and high levels of transparency, they ought to impart a pleasant feel when touched and also have a high aesthetic value, i.e., should not have any discoloration or spots.

Lastly, it should be possible to store not only aqueous but also oily or lipophilic fluids in containers made from films according to the invention.

A further problem on which the invention is based resides in indicating a method of producing multi-layer films according to the invention which should be possible to carry out as easily and inexpensively as possible.

In this respect, the new film should preferably be producible by co-extrusion technologies, whereby the compatibility of the material should make it possible to dispense with bonding agents or lining glues or layers of adhesives.

Yet another problem underlying the invention is to indicate the use of the films according to the invention.

These problems as well as further problems which may indeed not have been mentioned in detail but which readily arise from the initial discussion of the state of the art or which may be regarded as understood, are resolved by a multi-layer film of the present invention.

Specifically, the invention relates to an autoclaveable PVC-free multi-layer film, particularly for packing fluid, medicinal products and having at least three layers, namely and outer layer (A), and inner layer (I) and, disposed between them, a middle layer (M), each of which consists of up to 60 to 100% by weight of polypropylene materials and up to 40 to 0% by weight of a thermoplastic elastomer, the indications by weight respectively referring to the total weight of the respective layer, characterized in that following hot sterilization at 121° C. or higher temperatures using hot water steam spraying process, the multi-layer film displays no yield capable of being measured according to DIN EN ISO 527-1 to -3.

More specifically, the invention is characterized by a multi-layer film characterized in that the proportion of the total thickness of the film represented by the thickness of the middle layer (M) is in the range between 40 to 80%.

More specifically, the invention is characterized by a multi-layer film characterized in that the proportion of the total thickness of the film represented by the thickness of the middle layer (M) is in the range between 45 and 75%, or in the range between 60 and 80%.

More specifically, the invention is characterized by a multi-layer film characterized in that the proportion of the total thickness of the film represented by the thickness of the outer layer (A) is in the range between 30 and 7.5%.

More specifically, the invention is characterized by a multi-layer film characterized in that the proportion of total thickness of the film which is represented by the thickness of the inner layer (I) is in the range between 30 and 12.5%.

More specifically, the invention is characterized by a multi-layer film characterized in that the total thickness of the film is in the range between 120 and 300 μm, preferably between 150 and 250 μm and particularly preferably between 170 and 230 μm.

More specifically, the invention is characterized by a multi-layer film characterized in that the elasticity modulus of the material of the middle layer (M) is less than or equal to 250 MPa, preferably is less than or equal to 150 MPa, more preferably less than or equal to 135 MPa and particularly preferably less than or equal to 100 MPa, respectively measured according to DIN EN ISO 527-1 to -3.

More specifically, the invention is characterized by a multi-layer film characterized in that the material of the middle layer (M), following hot steam sterilization at 121° C. or higher temperatures in a hot water spray process, preferably also prior to a corresponding hot steam sterilization, has no yield measurable according to DIN EN ISO 527-1 to -3 in the case of a Type 2 test sample and at a pull-off rate of 200 mm/min.

More specifically, the invention is characterized by a multi-layer film characterized in that the material of the middle layer (M) has a yield, measurable according to DIN EN ISO 527-1 to 3 of less than or equal to 8 MPa in the case of a Type 2 test sample and at a pull-off rate of 200 mm/min.

More specifically, the invention is characterized by a multi-layer film characterized in that the elasticity modulus of material of the outer layer (A) is greater than 250 MPa, preferably greater than 300 MPa, particularly preferably greater than 400 MPa, respectively measured according to DIN EN ISO 527-1 to -3.

More specifically, the invention is characterized by a multi-layer film characterized in that the melting point of the (A) is greater than the melting point of the layer (I), the melting points being determined respectively for a single layer film or test specimens from the material of the respective layer (A) and (I) according to DIN 3146-C1b.

More specifically, the invention is characterized by a multi-layer film characterized in that the melting point of the layer (M) is less than the melting point of the layer (A) and greater that the melting point of the layer (I), the melting points being determined respectively for a single layer film or a test specimen from the material of the relevant layer (A), (M) and (I) according to DIN 3146-C1b.

More specifically, the invention is characterized by a multi-layer film characterized it that the payers (A), (M) and (I) have temperatures which, in respect of layers (M) are in the range from 35 to 75° C., expediently 35 to 70° C., preferably 40 to 65° C., while the layers (A) and (I) have temperatures in the region of less than or equal to 121° C.

More specifically, the invention is characterized by a multi-layer film characterized in that the layers (A), (M) consist by up to 100% by weight and the layer (I) by up to 60 to 100% by weight and preferably up to 70 to 90% by weight, of one or more polymers from the group consisting of homopolymers of polypropylene (homo-PP's), random copolymers of polypropylene (random co-PP's), block copolymers of polypropylene, flexible copolymers of polypropylene (co-FPO's), flexible copolymers of polypropylene (co-FPO's), while the layer (A) consists additionally by up to 40 to 0% by weight, preferably 30 to 10% by weight of styrene-ethylene/butylene-styrene block copolymers (SEBS).

More specifically, the invention is characterized by a multi-layer film characterized in that it consists of five layers having the sequence (A₁-M₁-A₂-M₂-I) or (A₁-M₁-M₂-A₂-I) or of seven layers in the sequence (A₁-M₁-A₂-M₂-A₃-M₃-I), the thickness of (M) and (A) being given as the sum of (M₁) and (A₁) respectively.

The invention also relates to a method of producing a multi-layer film according to the invention in which the layers (A) to (I) are co-extruded or lined with one another. The method is further characterized in that the film is co-extruded as a flat or tubular film or is lined as a flat film.

The invention also relates to the use of a film according to the invention as a packaging means for accommodation or storage of water-based parenteral fluids. The invention further relates to the use of a film according to the invention as a packaging means for accommodation or storage of fluid lipophilic emulsions.

By virtue of the fact that the multi-layer film, particularly for the packaging of fluid, medical products and having at least three layers, namely an outer layer (A), an inner layer (I) and, disposed between them, a middle layer (M), each of which consists of up to 60 to 100% by weight of polypropylene materials and of up to 40 to 0% by weight of a thermoplastic elastomer, the indication of weight respectively referring to the total weight of the appropriate layer, is characterized in that the multi-layer film, after hot steam sterilization at 121° C. or higher temperatures does not exhibit any yield which is measurable according to DIN EN ISO 527-1 to -3. According to the invention, it is surprisingly and unexpectedly possible to make available an at least three-layer film from which medical packaging can be produced and which outstandingly satisfies all the demands imposed by the Standards Institute and the industrial processors with regard to the physical properties of the packaging and which can at the same time consist entirely of polypropylene materials. Furthermore, it is possible to acquire a vast number of further additional advantages which include, inter alia:

The film according to the invention is extremely loadable dynamically and statically. Packaging made from a film according to the invention withstand a drop test according to DIN ISO 58363-15-1996 just as they withstand a permanent loading (pressure sleeve test) without damage.

For the first time, a film consisting only of polypropylene materials can be prepared which mechanical properties which correspond to multi-layer films comprising polyester or polyethylene materials.

The optical properties such as clarity, transparency or faults, of the film according to the invention are excellent even, and particularly after, hot steam sterilization. In this respect, no additives are required to improve the transparency.

The autoclavability of the films according to the invention is excellent. Even hot steam sterilization treatment at temperatures of more than 120° C. or 121° C. are withstood without damage and without any substantial impairment of the mechanical properties.

High-grade purity of the film promotes complete recyclability of the films, for example by the avoidance of polyesters, polyamides or PVC.

The film of the invention is extremely flexible and consequently allows the production of what are referred to as collapsible containers without problem.

The film of the invention can be sealed without problem both with permanently heated tools and also pulse-weldable.

The materials of the inner layer, compared with some known structures, permit shorter sealing times so that the time needed per package to be produced (empty bags and the like) drops and therefore the productivity rises accordingly.

The sealing layer of the film according to the invention makes it possible to influence and monitor the strength of the welded joints by controlling the sealing temperature and sealing time.

The film according to the invention is in certain circumstance also suitable for the production of bags for keeping oily or lipophilic fluids.

The film according to the invention has a relatively low water vapor permeability so that for certain applications, further barrier layers are superfluous. However, depending on the intended use, other layers may be combined with the film structure according to the invention for barrier purposes (water vapor barriers, oxygen barriers and others).

By minimizing the use of, or alternatively completely dispensing with, fractions consisting of thermoplastic elastomers from the group of styrene block copolymers in all or in the predominant number of the layers of the film made according to the invention, the price of the film per unit of surface area drops considerably.

The film according to the invention can be produced as a flat film. Therefore, it can have a regular thickness which is preferable for machinability of the film.

The film of the invention, in conjunction with its outstanding optical properties (gloss, clarity, transparency) has an outstanding printability and quite excellent structural integrity.

The multi-layer film according to the invention is particularly characterized in that, after hot steam sterilization at 121° C. or higher temperatures, it does not exhibit any measurable yield according to DIN EN ISO 527-1 to -3. The term “yield” within the framework of the present invention is used identically with the term “yield point” used in the standard mentioned. In connection with the invention, “yield” or “yield point” denotes a specific yield stress according to para. 4.3 1 (Definitions) from EN ISO 527-1 1996. In particular, where the yield stress mentioned is concerned this is by definition the first value in the tensile elongation diagram in which an increase in the elongation occurs with no rise in the stress. In the case of the films according to the invention, since this value is not reached, the no yield criterion is lacking. A tension at which an extension of the sample occurs with no further rise in tension cannot be detected in the case of films according to the invention following hot sterilization treatment. The films according to the invention therefore, in terms of tensile strength/elongation relationship, particularly with regard to the test according to Part 3 of the DIN EN ISO 127 “Test Conditions for Films and Panels”, German version October 1995, display a behavior which corresponds to curve d from Part 1 of DIN EN ISO 527 “Determination of Tensile Properties”, German version from April 1996. In the stress/elongation curves shown therein, the curve d stands for a tough material with no yield point, in contrast to brittle materials (curve a) and tough materials with a yield point (curves b and c). Thus, for the first time, the invention provides a polypropylene film for medical application which as a packaging film displays a virtually rubber-elastic behavior even after hot steam sterilization. Consequently, the film according to the invention combines two principles which have not in the past been considered possible. Films according to the invention are inter alia characterized in that they have neither a yield strength in the traverse direction (TD) nor in the machine direction (MD). The indication TD or MD by way of direction refers to the manufacture of the films.

As described, the film according to the invention can be sterilized by hot steam. To test for the presence of a yield according to DIN EN ISO 527-1 to -3, the films according to the invention are subjected to a sterilization treatment with heated steam at 121° C. The sterilization process used within the framework of the tests mentioned is known to a man skilled in the art particularly by the term “hot water spray process”. Further, the films of the invention can also be autoclaved and sterilized at other temperatures and with other or modified methods. These include for example the sterilization methods which function by using light, certain portions of visible spectrum of light or with other radiation.

So that the overall multi-layer film of the invention has no yield, the invention preferably uses a relatively thick middle layer and comparatively thinner inner and outer layers. One particular feature of the films according to the invention therefore resides in a specific ratio of the thickness of the middle layer to the overall thickness of the film. Consequently, the ratio of the thickness of the middle layer (M) to the overall layer of the films which arises as the sum of the thickness of the layers (A), (M) and (I), is a ratio from 40 to 75%. If the proportion of the middle layer (M) of the total thickness is less than 40% then this may mean that the flexibility of the bag is inadequate. If the proportion of the middle layer (M) of the total thickness of the multi-layer film is greater than 80%, then the static loadability may not be adequate and the pressure sleeve test of a filled bag will presumably no longer be withstood by such a film.

Preferred multi-layer films of the invention are characterized in that the proportion of the thickness of the middle layer (M) to the total thickness of the film is between 45 and 75%, and preferably between 50 and 70%, and particularly between 50 and 65%. Preferably, therefore, the middle layer is dominating in that the thickness is affected. With a relatively thick middle layer, and particularly in the especially preferred area, multi-layer films are produced which have a balanced property spectrum with regard to dynamic and static mechanical parameters as well as flexibility.

Deviating from the aforesaid thickness ranges, it may also be preferable for the proportion of the thickness represented by the middle layer (M) in relation to the total thickness of the film to be between 60 and 80%, preferably between 60 and 75% ad particularly preferably between 65 and 75%. This alternative is preferred above-all if particularly good dynamic properties are desired.

Also for the inner layer (I) and outer layer (A), preferred thickness are in proportion to the middle layer or intermediate layer (M).

In the case of preferred modifications of the multi-layer film according to the invention, the proportion of the thickness of the outer layer (A) to the total thickness of the film is in the range between 30 and 7.5%.

Of particular interest for the invention are also multi-layer (I) films which are characterized in that the proportion of the thickness of the inner layer (I) to the total thickness of the film is in the range between 30 and 12.5%.

Starting from a preferred thickness of the film (M) of 40 to 70% of the total thickness of the film, then for the layer (A) and also for the layer (I), there is the proportion of the total thickness of preferably 30 to 50%. With regard to the particularly preferred thickness range of the middle layer of 50 to 60%, then there are thickness for the outer layer (A) and the inner layer (I) which are in the range of respectively 25 to 17.5%.

Starting from a preferred thickness of the film (M) of 60 to 80% of the total thickness of the film, then for the layer (A) in one embodiment there is the proportion of the total thickness of the film between 15 and 7.5% whereas for the layer (I), a proportion of the total thickness of preferably 25 to 12.5% should be termed expedient.

The multi-layer of the invention can be produced over a wide range of thicknesses. As a function of the intended use, so thicker multi-layer films of a total thickness of more than 300 μm may be preferred but it is also possible to produce thinner films of less than 120 μm total thickness. A preferred embodiment according to the invention is characterized in that the total thickness of the films is in the range between 120 and 300 μm, preferably between 150 and 250 μm and particularly preferably between 170 and 230 μm.

The middle layer can impart a sufficient degree of flexibility to the overall multi-layer structure. The middle layer (M) is thereby characterized in that the elasticity modulus of the material of the middle layer (M) is less than or equal to 250 MPa and is preferably less than or equal to 150 MPa and is more preferably less than or equal to 130 MPa and particularly preferably less than or equal to 100 MPa, respectively measured according to DIN EN ISO 527-1 to -3. In this connection, the elasticity modulus for a film and for a corresponding test sample is determined in accordance with ISO 527-1 to -3, the test sample being produced from the material of the layer solely. If the layer (M) consists of more than one polymeric material (blend or compound), then the indicated value for the blend or compound is applicable. If the elasticity modulus of the middle layer is greater than 150 MPa, then the total multi-layer film may be inadequate in terms of flexibility. Of particular interest are the multi-layer films according to the invention in which the elasticity modulus of the middle layer (M) is in the range from 30 to 80 MPa, preferably 30 to 60 MPa and even more preferably 35 to 55 MPa and preferably between 35 and 50 MPa and particularly preferably between 40 and 45 MPa, respectively according to DIN EN ISO 527-1 to -3.

With regard to the middle layer (M), then preferably those polypropylene materials or compounds or polypropylene materials with thermoplastic elastomeric materials, preferably styrene block copolymers, are possible which display the toughest possible elasticity behavior. In an alternative embodiment, it might be favorable to use materials for which the yield limit is less than or equal to 8 MPa determined on a Type 2 specimen and at a pull-off rate of 200 mm/min. It can also be preferred to use even tougher materials. Therefore, from one case to another, it may be particularly advantageous to select for the middle layer (M) a material which, after hot steam sterilization at 121° C. or higher temperatures in hot water wearing test, preferably prior to a corresponding hot steam sterilization, has no yield measurable according to DIN EN ISO 527-1 to -3, with a Type 2 specimens and a pull-off rate of 200 mm/min. By a corresponding choice of materials, multi-layer films become accessible which, if the above-mentioned thickness ratios of the layers to one another is observed, may also allow relatively brittle, i.e., less viscous materials for the outer layer (A) in so far as the elasticity behavior of the materials is affected.

Particular multi-layer films according to the invention are inter alia present if the elasticity modulus of the material of the outer layer (A) is greater than the elasticity modulus of the material of the middle layer (B). Preferably, the elasticity modulus of the material of the outer layer (A) is greater than 250 MPa and is preferably greater than 300 MPa, and particularly preferably greater than 400 MPa, respectively measured according to DIN EN ISO 527-1 to -3.

Particular ranges for the elasticity modulus of the outer layer (A) are characterized in that the elasticity modulus of the material of the outer layer (A) is in the range from 300 to 600 MPa, preferably 400 to 600 MPa and even more preferably 450 to 550 MPa, preferably between 450 and 500 MPa and also particularly preferably between 400 and 450 MPa, respectively measured according to DIN EN ISO 527-1 to -3.

If a middle layer (M) is used it consists of a material having a yield which is small or slightly detectable in the traction-elongation diagram, it may be preferred to combine with this middle layer (M) an outer layer (A) which has a higher elasticity modulus. This may preferably assume values of more than 1000 MPa, particularly preferably greater than 1150 MPa. Preferred ranges are then between 900 and 1300 MPa, while values in the range from 100 to 1150 MPa appear to be even more favorable for the elasticity modulus.

It will be appreciated that with regard to the individual layers (A), (M) and (I), elasticity modulus is understood to mean a value which can be determined for specimens according to DIN EN ISO 527-1 to -3. The values indicated in this respect relate to specimens which have not been exposed to a sterilization treatment. According to the invention, as soon as yield point or elasticity modulus of films becomes important, then these are generally values which have been determined on films which have been exposed to sterilization treatment. Should the values be meant for unsterilized films, then this should be particularly indicated in each individual case.

With regard to thermal behavior (stability of the structure under heat during autoclave treatment) and also sealability of the inner layer (I), the invention permits excellent control over the entire spectrum of qualities required. Preferably, the melting point of the outer layer (A) is greater than the melting point of the inner layer (I).

It may also be preferred to select the layers (A), (M) and (I) so that the gradient of melting points of the individual layers is possible. For example, the layers (A), (M) and (I) may be chosen so that a gradient of the melting points of the individual layers is possible. Of particular interest in this regard are multi-layer films in which the melting point of the layer (M) is less than the melting point of the layer (A) and greater than the melting point of the layer (I), the melting points being determined respectfully for a single layer film made from the material of the respective layer (A), (M) and (I) according to DIN 3146-C1b. It will be understood that in connection with the invention, mention is made of melting points even though in some cases materials are used which do not have any “set melting point,” as is known in the classical sense for crystalline materials. In connection with the invention, melting point means a melting point within the meaning of DIN 3146-C1b, i.e., a transition in the DSC (differential scanning calorimeter).

Particularly preferred multi-layer films according to the invention are characterized in that the melting point of the layer (M) is in the range of 130 to 160° C., preferably 135 to 157.5° C. and particularly preferably 140 to 156° C., the melting point for a single layer film made from the material of layer (M) being determined according to DIN 3146-C1b. In this respect, it is noted that the melting temperatures of the individual layer (M) do not permit any direct conclusions concerning the softening of the material.

The Vicat temperature may be used to describe the softening behavior. The term softening point or softening temperature must be understood to refer to the temperature at which glass and amorphous or crystalline polymers of a glassy or hard-elastic nature turn into a rubber-elastic compound. A particular embodiment of the multi-layer film according to the invention may have layers (A), (M) and (I) with Vicat temperatures which are for the layer (M) in the range of from generally 35 to 75° C., preferably 35 to 70° C., particularly preferably 40 to 66° C. and quite particularly preferably 45 to 60° C., while the layers (A) and (I) have Vicat temperatures in the range from less than or equal to 121° C., respectively determined according to DIN 53460. Particularly interesting in this connection is the phenomenon that multi-layer films according to the invention withstand without problem a hot steam sterilization process at 121° C. although all the layers may have Vicat temperatures of less than 121° C. Among other things, the pressure parameters which are usually present during hot steam sterilization may be vital to retaining the structural integrity of the film or containers made therefrom during the treatment.

In the most general sense, the multi-layer film according to the invention consists of up to 60 to 100% by weight polypropylene materials per layer and up to 40 to 0% by weight of thermoplastic elastomers, preferably selected from the styrene block copolymer group.

Inter alia, the polypropylenes or polypropylene materials which can be used contain other homopolymers of propylene and copolymers of propylene with up to 25% (w/w) ethylene or a mixture (alloy, blend) of polypropylene with up to 25% (w/w) polyethylene. Where the coplymers are concerned, basically these may be random copolymers or block copolymers.

Where the polypropylene materials used are homopolymers of propylene or copolymers of propylene with ethylene, then for specific embodiments, it may be preferred to provide an ethylene unit content in the range of from 1 to 5% by weight, quite particularly preferably between 1.5 and 3% by weight, and even more preferably between 1.6 and 2.5% by weight, respectively related to the total weight of the copolymer. Particularly for the outer layer (A), a structure may be indicated which is advantageous for gloss, transparency, clarity and print-ability. Particularly preferably preferred, the outer layer is composed so that the proportion of ethylene units is in the range of between 1 and 5% by weight, while the material of the outer layer is derived from propylene.

Optionally, the individual layers of the multi-layer film according to the invention may contain a secondary amount of a thermoplastic elastomer, the thermplastic elastomer—as already mentioned above—being chosen from the group of styrene block copolymers. Other thermoplastic elastomers which may be used with the invention include polyether esters (TPE-E), polyurethanes (TPE-U), polyether amides (PTE-A) or even EPDM/PP blends as well as butyl rubber/PP blend or thermoplastic elastomers based on olefins (TPE-O). EPDM stands for terpolymers of ethylene, propylene and a non-conjugated diene and/or ethylene-alpha copolymers. Butyl rubber is understood to include copolymers of isobutylene with isoprene. It is possible to use a representative of the said groups of elastomeric compounds by itself. Mixtures of two or more compounds from a single group may be used or even mixtures of two or more compounds from more than one group of compounds may be used.

According to one embodiment of the invention, the use of block copolymers of styrene is preferred. In addition to others, the styrene block copolymers which may be used include styrene-ethylene/butylene-styrene triblock copolymers (SEBS), styrene-butylene-styrene diblock copolymer (SBS), styrene-ethylene/propylene-styrene triblock copolymers (SEPS), styrene-isoprene-styrene triblock copolymers (SIS) and mixtures of two or more of the aforementioned compounds. Of the said styrene block copolymers, the use of SEBS is preferred, by virtue of the particular suitability of this thermoplastic elastomer for applications in the medical field.

The proportion of thermoplastic elastomer may vary from layer to layer. Preferably, the middle layer (M) has the smallest possible proportion of thermoplastic elastomer. Preferred ranges are 20 to 0% by weight and particularly preferred 10 to 0% by weight and quite particularly preferably less than 5% by weight and mostly preferably the layer (M) is free from a thermoplastic elastomer which is not a polypropylene materials within the meaning of the invention. Accordingly, the proportion of polypropylene materials is preferably between 80 to 100% by weight; even more preferred, it is between 90 and 100% by weight. preferably greater than 95% by weight and most preferably 100% by weight, respectively related to the total weight of the layer (M).

The same applies to the construction of the outer layer (A). The outer layer (A) preferably has the smallest possible proportion of thermoplastic elastomer. Preferred ranges are from up to 20 to 0% by weight, particularly preferred 10 to 0% by weight and quite particularly expediently less than 5% by weight and mostly preferred the layer (A) is free from a thermoplastic elastomer. Accordingly, the proportion of polypropylene material is preferably between 80 to 100% by weight, even more preferably between 90 and 100% by weight and is expediently greater than 95% by weight and mostly preferably 100% by weight, respectively related to the total weight of the layer (A).

With regard to the composition of the inner layer (I), firstly also the basic principle applies that the smallest possible proportion of thermoplastic elastomer is desired. Thus, in an embodiment of the inner layer (I) it is true in turn that preferred ranges of 20 to 0% by weight result, particularly preferred ranges being 10 to 0% by weight and quite particularly preferably less than 5% by weight and mostly preferably the layer (I) is free from thermoplastic elastomers. Correspondingly, the proportion of polypropylene material in the layer (I) is preferably between 80 to 100% by weight, even more preferably between 90 and 100% by weight and is preferably greater than 95% by weight and most preferably 100% by weight, respectively referring to the total weight of the layer (I).

However, for a specific change of the sealing properties and control of welded seams, it may be particularly advantageous to provide about 10 to 30% by weight and preferably 15 to 25% by weight and particularly preferably about 20% by weight of thermoplastic elastomer in the inner layer (I). Accordingly, the preferred polypropylene material content of the inner layer (I) corresponds to 90 to 70%, 85 to 75% and particularly expediently up to about 20% by weight, respectively referred to the total weight of the layer (I).

On the basis of the aforementioned remarks, a preferred embodiment comprises a film where the layers (A) and (M) consist of 100% by weight and the layer (I) consists up to 90 to 70% by weight of polypropylene materials, these figures being respectively based on the total weight of the appropriate layer. It is particularly preferred if the remaining 10 to 30% by weight of layer (I) consists of one or more SEBS(s).

Consequently, a particularly preferred multi-layer film is characterized in that the layers (A) and (M) consist of 100% by weight and layer (I) consists of up to 60 to 100% by weight, preferably 70 to 90% by weight, of one or more polymers from the group consisting of homopolymers of polypropylene (homo-PP's), random copolymers of polypropylene (random-Co-PP's), block copolymers of polypropylene, flexible homopolymers of polypropylene (FPO's), flexible copolymers of polypropylene (Co-FPO's), while the layer (I) additionally has 40 to 0% by weight, preferably 30 to 10% by weight of styrene-ethylene/butylene-styrene block copolyer (SEBS).

Of particular interest for carrying out the invention are such homopolymers and especially copolymers of propylene with ethylene, with a high flexibility. Particulalry suitable materials include substantially amorphous binary random copolymers consisting essentially of from about 10 to about 30 wt. % of ethylene and from about 70 to about 90 wt. % of propylene, said copolymers having a tacticity index m/r ranging between 3.0 and 4.0 and having a propylene inversion value of about 0.15 and below as determined by ¹³C NMR spectra. Random copolymers of propylene and ethylene compying with these features are for instance obtainable by employing as catalyst during polymerization a composition of a solid catalyst component produced by a method comprising co-communicating magnesium halide support base and aluminum trihalide as well as titanium tetrahalide and a co-catalyst component comprised of a mixture of trialkylaluminum and an alkylaluminum halide. U.S. Pat. No. 4,858,757 discloses corresponding polymers. Process for the production of the polymers is disclosed by U.S. Pat. No. 4,736,002 and U.S. Pat. No. 4,847,340, respectively.

The flexible homopolymers of propylene (FPO's) as well as the flexible copolymers of propylene with ethylene (Co-FPO's) of Huntsmann, which are obtainable as Rexflex® FPO, belong to the propylene materials which are particularly preferred for use in the films of the invention.

Related to the total multi-layer structure of the films according to the invention, also by virtue of the ratios of the thicknesses of the layers with respect of one another, the result is a film with a high content of polypropylene materials. In a preferred embodiment, the film according to the invention contains up to at least 90% by weight of polypropylene materials in relation to the total weight of the multi-layer film. Even more preferably, films which contain more than 92% by weight, up to 94% by weight or more, up to 96% by weight or more or up to at least 97.5% by weight of polypropylene materials are preferred.

Particular films according to the invention have by way of example the following structure:

(A) a first or outer layer of polypropylene copolymer with 2 to 3% by weight ethylene units;

(M) a second or middle layer consisting of a polypropylene homopolymer with a defined tacticity;

(I) a third or sealing layer of a blend of polypropylene and an elastomeric material

A corresponding structure for a film particularly useful for the manufacture of containers, bags or the like which are intended to accommodate lipophilic fluids for parenteral nourishment has been found according to the invention.

In this sense, films having the following structure are particularly expedient.

(A) a first or outer layer of polypropylene copolymer with 20 to 3% by weight ethylene units, with a thickness of 10 to 30 μm;

(M) a second or middle layer consisting of a polypropylene homopolymer with a definite tacticity and a thickness between 100 and 200 μm;

(I) a third or sealing layer of a blend of polypropylene and an elastomeric material with 0 to 40% by weight, preferably 10 to 30% by weight and particularly preferably about 20% by weight, respectively based on the total weight of the layer (I) of thermoplastic elastomer, preferably a thermoplastic elastomer based on a styrene block copolymer and particularly preferably an SEBS, with a thickness in the range from 20 to 80 μm.

Quite particularly expedient in this sense are films with one of the following structures:

(A) a first or outer layer of Rexene PP23M10CS264 (Huntsmann Corp.), thickness of about 20 μm;

(M) a second or middle layer of Rexflex FPO WL110 (Huntsmann Corp.) with a definite tacticity and a thickness of about 140 μm;

(I) a third or sealing layer of a blend of 80% by weight polypropylene and 20% by weight SEBS with a thickness of about 40 μm.

For manufacturing containers for storing water-based parenteral fluids, the following films are inter alia of particular interest.

(A) a first or outer layer of polypropylene homopolymer, preferrably from the family of flexible polypropylene homopolymers;

(M) a second or middle layer consisting of a polypropylene copolymer from the family of flexible polypropylene copolymers with a low ethylene content;

(I) a third or sealing layer of a blend of polypropylene and an elastomeric material.

In this sense, films are particularly preferred which have the following structure:

(A) a first or outer layer of polypropylene homopolymer with a thickness of 20 to 60 μm;

(M) a second or middle layer of a polypropylene copolymer with an ethylene content in the range of from 1 to 3% by weight and a thickness of between 60 and 180 μm;

(I) a third or sealing layer of a blend of polypropylene and elastomeric material with 0 to 4% by weight, preferably 10 to 30% by weight and particularly preferably about 20% by weight, respectively based on the total weight of the layer (I) of thermoplastic elastomer, preferably a thermoplastic elastomer based on a styrene block copolymer, particularly preferably an SEBS, with a thickness in the range from 20 to 80 μm.

In this sense, films are particularly preferred which have the following structure:

(A) a first or outer layer of WL113 of Huntsmann with a thickness of about 30 μm;

(M) a second or middle layer of WL210 of Huntsmann with an ethylene content of about 1.6% by weight and a thickness of about 130 μm;

(I) a third or sealing layer consisting of a blend of 80% by weight polypropylene and 20% by weight SEBS with a thickness of about 30 μm.

In this sense, also films with the following structure are quite particularly preferred.

(A) a first or outer layer of WL113 of Huntsmann, with a thickness of about 50 μm;

(M) a second or middle layer of WL210 of Messrs. Huntsmann with an ethylene content of about 1.6% by weight and a thickness of about 90 μm;

(I) a third or sealing layer of a blend of 80% by weight polypropylene and 20% by weight SEBS with a thickness of about 50 μm.

Quite particularly preferred in this sense are furthermore films which have the following structure:

(A) a first or outer layer of WL113 of Huntsmann with a thickness of about 50 μm;

(M) a second or middle layer of WL210 of Huntsmann with an ethylene content of about 1.6% by weight and a thickness of about 90 μm;

(I) a third or sealing layer consisting of a random polypropylene copolymer 29450 of Fina with a thickness of about 50 μm.

With the invention it is particularly, and in a particular variation thereof, also possible, as already described, to successfully produce films which consists entirely, i.e., up to 100% by weight of polypropylene materials. As a result of the optional restriction to at least 90% by weight polypropylene materials, excellent compatibility of the layers with one another is achieved so that no bonding agents or bonding layers are required. Therefore, the risk of delamination of the layers is reduced.

To a certain degree, the properties of the individual layers contribute to the entirely advantageous spectrum of qualities of the entire multi-layer film, although not all the properties of the film can be derived directly from the properties of the individual layers.

In a preferred embodiment of the invention, the outer layer (A) can contribute to the stability of the film during welding and impart the desired rigidity and stretching tension as well as impact-resistance to the material. The middle layer (M) can give the film suitable flexibility, while the inner layer (I) makes it possible to produce peelable seams of differing and defined strength which can be controlled by the welding conditions such as temperature, pressure and time.

The multi-layer film according to the invention preferably comprises three layers. This construction is easy to produce and is adequate for all applications. Nevertheless, the film according to the invention can also be constructed in five, seven or even more layers. Particular multi-layer films according to the invention are, inter alia, characterized in that they consist of five layers in the sequence (A₁-M₁-A₂-M₂-I) or seven layers with the sequence (A₁-M₁-A₂-M₂-A₃-M₃-I), the thickness of (M) and (A) yielding as a sum (Mᵢ) or (Aᵢ)

Equally favorable are films with a sequence of layers with the following pattern: (A₁-(M₁-M₂-A₂-I). This structure proves to be particularly favorable if the layers M₁ consist of flexible homopolymers of propylene.

The film of the invention can be made by methods known in the art. Preferred methods of producing a multi-layer film according to the invention comprise lining or co-extruding the layers (A) to (I) with one another.

Particularly expedient are methods in which the film according to the invention is co-extruded as a flat or tubular film or is lined as a flat film.

Manufacture of the film according to the invention is consequently carried out in a manner known in the art, whereby it is possible to produce sheets of suitable size. The sheets can then be used for producing containers for medical purposes. The containers to be produced for medical fluids may have one or more compartments. The manufacture and filling of the bags or containers can take place according to methods known in the art.

The film according to the invention has a wide range of use. Inter alia, the conceivable uses include bags for storing liquid substances for nutrition, medical solutions or liquids. A preferred use is as a packaging material for water-based parenteral fluids. Other possible uses relate to the use as a packaging material for holding liquid lipophilic emulsions, possibly as a packaging medium for lipophilic medical solutions.

Other concrete possibilities for use of the films of the invention include filling and storage of medical liquids and solutions such as cooking salt solution, blood, blood substitute solutions, dialysis solutions, amino acid solutions, fat solutions, emulsions, but also pasty or viscous, i.e., still flowable substances.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### DETAILED DESCRIPTION OF PREFERRED EMBODIMENTS OF THE INVENTION

A preferred embodiment of the present invention is explained in detail hereinafter with reference to Examples and Comparative Examples.

1. Methods of Determining the Physical Parameters of the Materials Used

The physical parameters listed below for the materials were measured, and tabulated values were received from the manufacturers. For the materials indicated in Table 1, the values were determined in the way indicated in the respective Standard to which reference is made. Where the Standard accepts various possible determination methods, then in each case the alternative form of determination usual in the field in question was used. The following Regulations were used for determining the characteristic values:

(1) MFR in [g/10 min] was determined according to DIN ISO 1133; MFR is identical to MFI (melt index), the melt index was ascertained under 21.6 N loading and 230° C. (previously DIN 53735:1983-01);

(2) the vicat temperature in [° C.] was determined according to DIN ISO 306/A; this relates to the softening temperature which corresponds to that temperature at which a steel pin of circular cross-section of 1 mm² and at least 3 mm in length penetrates the test sample to a depth of 1 mm when a force of 1 kp is applied (previously DIN 53 460:1976-12).

(3) the melting point was determined in [° C.] according to DIN 3146-C1b; DSC measurement maximum of the melting curve, at a rate of 20 K/min;

(4) the density is indicated in [g/cm³], determined according to DIN ISO 1183;

(5) the elasticity modulus [MPa] is determined with reference to the individual materials, in accordance with DIN ISO 527-1 to -3, this is in particular the elasticity modulus determined from the tension test, the evaluation being carried out with computer assistance according to Note 1 from para 4.6 of EN ISO 527-1:1996. For films, particularly multi-layer films, determination was conducted in accordance with DIN ISO 527-1 to -3, the elasticity modulus being ascertained by the Sekant method which is usually applied in synthetic plastics technology;

(6) yield in [MPa] is determined according to DIN ISO 527-1 to -3; the test speed used always amounted to 200 mm/min (pull-off speed of the traverse); the test specimen corresponding to Type 2;

(7) thickness of the films [μm] according to DIN ISO 4593, in the case of films with a thickness of less than 0.01 mm according to DIN ISO 4591.

The following Table 1 summarizes the results of analyzing the physical parameters for materials used in the films according to the invention, for materials used in films according to the Comparative Examples and for materials which are not used in the Examples or in the Comparative Examples.

TABLE 1
Characteristics of the materials used in the films of the
examples of the invention and used in the films
of the comparative examples

| | MFR | | Melting | | | |
|---|---|---|---|---|---|---|
| | [g.10 | | Point | Density | E-modulus | Yield |
| Material | min] | [° C.] | [° C.] | [g/cm³] | [MPa] | [MPa] |
| PPC1 | 5 | * | 128 | 0.89 | 480 | 15 |
| PPC2 | 10 | * | 150 | 0.9 | 1055 | 28 |
| PPC3 | 5 | 52 | 148 | 0.89 | 43 | No Yield |
| PPH2 | 8 | 154 | 161-165 | 0.9 | 650-750 | 40-60 |
| PPH3 | 6 | 119 | 160 | 0.89 | 441 | 24 |
| PPH4 | 10 | 102 | 159 | 0.89 | 317 | 12.8 |
| PPT1 | 6.5 | 116 | 132 | 0.89 | 770 | 16 |
| PPT2 | 8 | | 144 | 0.89 | 1100 | 24 |
| PPT3 | 8 | 110 | 138-142 | 0.90-0.91 | 200 | 10.5 |
| PPC1/ | 4 | 102 | * | 0.9 | * | * |
| TPE1 | | | | | | |
| PPH5 | 16 | 63 | 155 | 0.88 | 94 | 6 |
| PPH6 | 5.5 | 67 | 156 | 0.89 | 117 | 7 |
| PPH7 | 6 | 74 | 156 | 0.89 | 131 | 7.7 |
| PPH8 | 1.5 | 64 | 152 | 0.89 | 97 | 6.4 |
| PPH9 | 1.5 | 69 | 154 | 0.89 | 124 | 8 |
| PPH10 | 1.8 | 116 | 158 | 0.89 | 428 | 16 |
| PPH11 | 3.5 | 69 | 155 | 0.89 | 117 | 8 |
| PPC4 | 1.5 | 49 | 145 | 0.88 | 55 | No Yield |
| PPC5 | 8.5 | 50 | 147 | 0.88 | 45 | 5.2 |
| PPC6 | 8 | 122 | 138-142 | 0.90-0.91 | 370 | 5.2 |
| PPC7 | 8 | 153 | 148-154 | 0.90-0.91 | 550 | 5.2 |
| PPH13 | 8 | 152 | 162-166 | 0.90 | 670 | 5.2 |

* According to Manufacturers' specifications - not measurable
PPC1: Z9450 of Fina is a random polypropylene copolymer.
PPC2: PP13M10cs264 of Huntsmann Polymers is a random polypropylene copolymer.
PPC3: WL210 of Huntsmann is a random polypropylene copolymer of the REXflex FPO polymer family with 16% ethylene units.
PPC4: WL303 of Huntsman is a random polypropylene copolymer from the REXflex FPO polymer family.
PPC5: WL223 of Huntsmann is a random polypropylene copolymer of the REXflex FPO polymer family.
PPC6: KFC2008 of Borealis is a random polypropylene copolymer.
PPC7: KFC2004 of Borealis is a random polypropylene copolymer.
PPH2: HD601F of Borealis is a polypropylene homopolymer with more than 99.8% polypropylene polymer.
PPH3: WL113 of Huntsmann is a polypropylene homopolymer from the REXflex FPO polymer family.
PPH4: WL107 of Huntsmann is a polypropylene homopolymer from the REXflex FPO polymer family.
PPT1: TD 120 H of Borealis is a C2/C4 terpolymer with more than 99.7% polypropylene copolymer.
PPT2: RD418H-03 of Borealis is a C3/C4 random copolymer with more than 99.5% polypropylene copolymer.
PPT3: K2033 of Borealis is a hererophasic polypropylene copolymer (RAHECO).
PPC1/TPE1: NPPOONPOINA of Ferro Corporation is a compound made of 80% PPC1 and 20% TPE1 (w/w).
TPE1: Kraton G1652 of Shell Nederland Chemie B.V. is a linear styrene-(ethylene-butylene)-styrene block copolymer (SEBS).
PPH5: WL101 of Huntsmann is a polypropylene homopolymer from the REXflex FPO polymer family.
PPH6: WL102 of Huntsmann is a polypropylene homopolymer from the REXflex FPO polymer family.
PPH7: WL110 of Huntsmann is a polypropylene homopolymer from the REXflex FPO polymer family.
PPH8 WL111 of Huntsmann is a polypropylene homopolymer from the REXflex FPO polymer family.
PPH9: WL114 of Huntsmann is a polypropylene homopolymer of the REXflex FPO polymer family.
PPH10: WL116 of Huntsmann is a polypropylene homopolymer of the REXflex FPO polymer family.
PPH11: WL117 of Huntsmann is a polypropylene homopolymer of the REXflex FPO polymer family.
PPH13: KFC201 of PCD is a polypropylene homopolymer.

2. Manufacture of the Films

From the above-described materials and possibly other materials not indicated in Table 1, films were produced according to a manner well known to one skilled in the art. Basically, production was based on flat films or tubular films as follows:

Flat (cast)-film:

The PP granulates are fed via a quantitative dispensing system to extruders appropriate for the individual layers. By means of heat and friction, the materials are plasticised, introduced into a distributor unit in the previously-described layer arrangement and poured onto a sheet die through a water cooled and rotating roller.

Layer thickness and overall thickness are determined by the extruder output and the pull-off rate of the cooling roll.

The cooled film is wound into master rolls on a winding apparatus.

Blown (tubular)-film, water cooled:

The PP granulates are fed via a dispensing system to extruders appropriate for the individual layers. By means of heat and friction, the materials are plasticized, introduced into a blower head in the previously-described layer arrangement and are formed by a circular die into a tubular form which is cooled in a water-cooled calibrating apparatus.

Layer thickness and overall thickness are determined by the extruder output and the pull-off rate of the apparatus.

The cooled film is wound onto master rolls on a winding apparatus.

The films according to the invention having the compositions and properties indicated in Table 2 or films corresponding to commercially obtainable films as in the Comparative Examples were analyzed.

TABLE 2
Composition of films according to the invention
and according to the comparative examples

| | Pro. | | | | Pro. | | | | Pro. | | | |
|---|---|---|---|---|---|---|---|---|---|---|---|---|
| | by | | | Pro. | by | | | Pro. | by | | | Pro. |
| | Wgt. | Mat. | Tkn. | Tkn. | Wgt. | Mat. | Tkn. | Tkn. | Wgt. | Mat. | Tkn. | Tkn. |
| CMP | 80 | PPC1 | 19 | 11 | 100 | PEC1 | 132 | 78 | 100 | PET1 | 19 | 11 |
| Ex. 1 | 20 | TPE1 | | | | | | | | | | |
| CMP | 70 | PPC2 | 53 | 27 | 50 | PPC2 | 110 | 68 | 85 | PPH1 | 32 | 16 |
| Ex 2 | 15 | TPE2 | | | 15 | TPE2 | | | | | | |
| | 15 | TPE3 | | | 35 | TPE3 | | | 15 | TPE3 | | |
| CMP | 80 | PPC2 | 40 | 24 | 100 | PPH4 | 100 | 59 | 100 | PPC2 | 30 | 18 |
| Ex. 3 | 20 | TPE2 | | | | | | | | | | |
| Ex. 4 | 80 | PPC1 | 40 | 24 | 100 | PPC3 | 100 | 59 | 100 | PPH3 | 30 | 18 |
| | 20 | TPE1 | | | | | | | | | | |
| CMP | 70 | PPC2 | 30 | 18 | 50 | PPC2 | 110 | 68 | 85 | PPH1 | 40 | 24 |
| Ex. 5 | 15 | TPE2 | | | 15 | TPE2 | | | | | | |
| | 15 | TPE3 | | | 35 | TPE3 | | | 15 | TPE3 | | |
| Ex. 6 | 80 | PPC1 | 30 | 16 | 100 | PPC3 | 130 | 68 | 100 | PPH3 | 30 | 16 |
| | 20 | TPE1 | | | | | | | | | | |
| Ex. 7 | 80 | PPC1 | 50 | 26 | 100 | PPC3 | 90 | 48 | 100 | PPH3 | 50 | 26 |
| | 20 | TPE1 | | | | | | | | | | |
| Ex. 8 | 100 | PPC1 | 50 | 26 | 100 | PPC3 | 90 | 47 | 100 | PPH3 | 50 | 26 |
| CMP | 100 | OOT1 | 59 | 28 | 70 | PPT5 | 100 | 56 | 100 | PPT2 | 30 | 17 |
| Ex. 9 | | | | | 30 | PPC3 | | | | | | |
| CMP | 100 | PPT1 | 50 | 28 | 30 | PPT3 | 100 | 56 | 100 | PPT2 | 30 | 17 |
| Ex. 10 | | | | | 70 | PPC3 | | | | | | |
| CMP | 100 | PPT1 | 50 | 28 | 30 | PPT3 | 100 | 56 | 100 | PPH2 | 30 | 17 |
| Ex. 11 | | | | | 70 | PPC3 | | | | | | |
| Ex. 12 | 80 | PPC1 | 40 | 20 | 100 | PPH7 | 140 | 70 | 100 | PPC2 | 20 | 10 |
| | 20 | TPE1 | | | | | | | | | | |
| Ex. 13 | 100 | PPC6 | 40 | 20 | 100 | PPH7 | 140 | 70 | 100 | PPC7 | 20 | 10 |
| CMP | 80 | PPC1 | 154 | 77 | 100 | TPE2 | 20 | 10 | 100 | FET2 | 26 | 13 |
| Ex. 14 | 20 | TPE1 | | | | | | | | | | |
| CMP. | 100 | PPH | 25 | 12.5 | 20 | PPH12 | 125 | 62.5 | 70 | PPH1 | 50 | 25 |
| Ex. 15 | | 13 | | | 50 | TPE1 | | | | 2 | | |
| | | | | | 30 | PZ1 | | | 30 | TPE1 | | |
| | Inner layer | | | | Middle layer | | | | Outer layer | | | |
| | (I) | | | | (M) | | | | (A) | | | |
| Ex./ | Pro | | | Pro | Pro | | | Pro | Pro | | | Pro |
| CMP | Wgt. | | Tkn | Tkn | Wgt | | Tkn | Tkn | wgt. | | Tkn | Tkn |
| Ex. | [%] | Mat. | [μm] | [%] | [%] | Mat. | [μm] | [%] | [%] | Mat. | [μm] | [%] |
| Ex. 16 | 80 | PPC1 | 40 | 20 | 100 | PPCol | 140 | 70 | 110 | PPC7 | 20 | 10 |
| | 20 | TPE1 | | | | | | | | | | |
| Ex. 17 | 80 | PPC1 | 40 | 20 | 100 | PPT4 | 140 | 70 | 100 | PPC2 | 20 | 10 |
| | 20 | TPE1 | | | | | | | | | | |
| Ex. 18 | 80 | PPC1 | 40 | 20 | 80 | PPT3 | 140 | 70 | 100 | PPC7 | 20 | 10 |
| | 20 | TPE1 | | | 20 | PPC8 | | | | | | |
| CMP Ex Comparative Example particularly Comparative Example 1 refers to a film with the abbreviation M312 obtainable by Cryovac, whereby the film's structure is supposed to be in compliance with U.S. Pat. No. 4,643,926; Comparative Example 14 refers to a film named Excell commercially available from B. Baun McGaw, whereby the structure of the | | | | | | | | | | | | |
| #film is disclosed in U.S. Pat. No. 4,803,102; Comparative Example 15 refers to a film commercially available by Sengewald, whereby the film's structure is disclosed in covered by DE 196 40 038; | | | | | | | | | | | | |

Ex Example according to the invention
Pro. Wgt. [%] Proportion by weight [%]
Mat. Material
Tkn Thickness [μm]
Pro. Tkn [%] Proportion thickness [%]
PPH1: 41E4cs278 of Huntsmann is a polypropylene homopolymer
TPE2: Kraton G1657 of Shell Nederland Chemie B.V. is a linear styrene-(ethylene-butylene)-styrene-block copolymer (SEBS)
TPE3: Tuftex H1085L of Asahi Chemical Industry Co. is a hydrogenated styrene butadiene block copolymer
PEC1: SLP 9069 of Exxon Chemical is an ethylene-alpha-olefin
PHT1 Ecdel 9965 of Eastman Chemical Company is a copolyester ether
PET2 Copolyester material
PPH12: Polypropylene homopolymer
PZ1: White medical oil

3. Determining the Properties of the Films

The commercially obtainable films, like the Examples of films according to the invention or other films produced for purposes of comparison, were tested to determine their traction-elongation behavior according to DIN ISO 527-1 to -3. The results of these tests are shown in Table 3.

TABLE 3
Results of the traction-elongation tests for sterilized films
according to the invention and for sterilized comparative films

| | Elasticity | | | |
|---|---|---|---|---|
| | modulus (MPa) in N/mm² | | Yield to N/mm² | |
| Examples & | DIN ISO 527-1 to −3 | | DIN ISO 527-1 to −3 | |
| Comparisons | MD | TD | MD | TD |
| Comp. Ex. 1 | 99.03 | 98.01 | None | None |
| Example 2 | 382.35 | 171.39 | 18.6 | None |
| Comp. Ex. 3 | 87.8 | 119.9 | 11.6 | 10.2 |
| Example 4 | 187.22 | 275.54 | None | None |
| Comp. Ex. 5 | 325.48 | 241.13 | 14.17 | 14.88 |
| Example 6 | 191.01 | 170.44 | None | None |
| Example 7 | 109.41 | 93.1 | None | None |
| Example 8 | 212.08 | 191.78 | None | None |
| Comp. Ex. 9 | 403.75 | 421.55 | 20.4 | 19.39 |
| Comp. Ex. 10 | 347.27 | 354.57 | 16.74 | 16.75 |
| Comp. Ex. 11 | 400.51 | 375.92 | 17.97 | 16.44 |
| Example 12 | 195.74 | 158.25 | None | None |
| Example 13 | 166.55 | 183.70 | None | None |
| Comp. Ex. 14 | 377.7 | 293.8 | 18.69 | 16.53 |
| Comp. Ex. 15 | 311.0 | 250.1 | 15.84 | None |
| | Elasticity | | | |
| | modulus (MPa) in N/mm² | | Yield in N/mm² | |
| Examples & | DIN ISO 527-1to 3 | | DIN ISO 527-1to 3 | |
| Comparisons | MD | TD | MD | TD |
| Ex. 16 | 72.43 | 56.04 | None | None |
| Ex. 17 | 187.66 | 119.34 | None | None |
| Ex. 18 | 246.74 | 148.71 | None | None |

Comp. Ex. Comparative example
MD Measured in machine direction
TD Measured crosswise to machine direction

It can be seen that the films in accordance with the invention lack a yield both in the machine direction and if the measurement is carried out crosswise to the machine direction. Except one of the comparative examples (Vgl. 1) all of the other comparative examples comprise a yield in both directions (MD as well as TD), like for instance Vgl. 5 or 14, or only in machine direction (MD), like e.g. Vgl. 2 or Vgl. 15. Vgl. 1, which does not comprise a yield after sterilization of the film, has the drawback of a material mix (outer layer is comprised of polyester). In this regard the invention for the first time provides a film for medical fluids, composed exclusively of polyolefine materials and optional rubber like materials, and combining stiffness and hardness of the film with excelling impact resistance. As a consequence PVC and PET can be avoided without sacrificing the preferred mechanical properties of these materials.

4. Manufacture of Bags from the Films

A selection of the films according to the invention and of the comparative examples are used to produce packaging bags for liquid, medical products. These so-called intravenous bags were produced in the following way:

From the films obtained in the manner described hereinabove, samples are cut to the appropriate length and welded to one another in a non-detachable fashion on all sides by hot contact welding with two flexible hose connections. The two hose connections are closed in a leak-proof manner with push-in connectors.

The films are welded in a welding apparatus employing heated welding bars. The parameters ascertained in preliminary tests for temperature, time and surface pressure during welding are indicated hereinafter, as is also the amount of water with which the bags were filled. The welding bar adjoining the straight seams was applied with a surface pressure of 30 to 60 N/cm² over a 2 second welding cycle while a second welding bar was applied for a period of 3 to 6 seconds in order to weld in the connecting hoses, with 50 to 120 N/cm².

The finished sample bags were respectively filled with 1 liter of water. The finished and filled bags were sterilized. Sterilization was carried out in an autoclave at 121° C. for 15 to 30 minutes under wet steam (a heated water spray process).

5. Methods of Examining the Physical Properties of the Bags

(a) Drop Test. The bags have to withstand being dropped onto a hard non-resilient panel which has a smooth surface without damage according to DIN 58363-15 (Infusion Containers and Accessories). The following requirements which are described in Table 4, are based on the quantity with which the bags are filled.

TABLE 4
Requirements of the drop test according to
DIN 5863-15

| Nominal amount of | Drop height in m at room |
|---|---|
| the filling in ml | temperature |
| Up to 750 | 2.0 |
| Over 750 and up to 1500 | 1.5 |
| Over 1500 and up to 2500 | 1.0 |
| Over 2500 | 0.5 |

The test is passed when visual inspection shows that no bag has broken and no liquid is leaking.

(b) Pressure Sleeve Test. The pressure sleeve test is an application oriented test which is applied as follows in the case of pressurized infusions and patient monitoring:

For a pressurized infusion, infusion bags must be capable of withstanding an excess-pressure of approximately 400 mm Hg for approximately 1 hour in the commercially available pressure sleeves.

For monitoring on the patient, the bags have to withstand an excess pressure of 39,996.71 Pa (300 mm Hg) for 7 days at a temperature of 20 to 28° C. Higher excess pressures of up to 53,328.95 Pa (400 mm Hg) may occur short-term for approximately 1 hour.

The bags obtained according to 4 were subjected to a drop test according to 5(a) and a pressure sleeve test according to 5(b). Bags made from films according to the invention withstood tests 5(a) and 5(b) without problem, whereas some bags made from films of the comparative examples failed.

6. Comparison of the Properties of Example 12 and Comparative Example 14

Both films comprised the same materials for the inner layer (I) or sealing layer but differ with regard to the materials of the middle layer (M) and outer layer (A).

Firstly, the processability and the tension-elongation properties of the two films were compared. With both films, it was possible to produce welded joints of different strengths by altering the welding temperature. At low welding temperatures, i.e., 116 to 118° C., peelable seams are obtained, whereas with higher welding temperatures, i.e. 126 to 130° C., permanent sealed seams are obtained. The processing time for contoured seams can be determined by making up bags under various welding conditions (temperature, pressure, time), filling them with water, sterilizing them and then subjecting them to a drop test. If the welded seam breaks open, this indicates that the welding temperature was wrong. If the film tears, this indicates that the impact strength of the material was too low. The results of these tests are given in Table 5.

TABLE 5
Results of Drop Tests

| | | | | Passed/ | |
|---|---|---|---|---|---|
| Bag | Welding | | | Overall | Passed/Overall |
| Size | Temperature | Height | Autoclaved | [Example | [Comparative |
| [ml] | [° C.] | [m] | [Yes/No] | 12] | Example 14] |
| 500 | 126 | 2.0 | Yes | 40/40 | 39/40 |
| 500 | 128 | 2.0 | Yes | 40/40 | 40/40 |
| 500 | 130 | 2.0 | Yes | 40/40 | 38/40 |
| 1000 | 130 | 1.5 | Yes | 5/5 | 4/5 |
| 1000 | 130 | 1.5 | No | 5/5 | 5/5 |

The results set out in Table 5 provide clear evidence that the processing time for industrial production is long enough and that even after a sterilization treatment the film retains its properties. Furthermore, its properties are the same as or better than the properties of a known film using polyester (Comparative Example 14). In particular, films according to Example 12 and Comparative Example 14 are equally flexible when filled. Furthermore, the film according to Example 12 satisfies the European Pharmacopoeia (Ph. Eur. 3.2.7 and others). The permeability to steam offered by the example film is so great that the storage time for products in containers made from the film is at least one year. The film according to the invention has excellent transparency before and after sterilization treatment. However, in all, the price of the raw materials (polymer materials) for producing the film in Example 12 is only about half that of the raw materials for the film according to Comparative Example 14. This can be attributed substantially to an altogether lesser amount of SEBS, as well as to a reduction in the compounding steps prior to extrusion.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A multi-layer film comprising at least three layers, an outer layer (A), an inner layer (I) and, disposed in between, a middle layer (M), each of which consists of up to 60 to 100% by weight of polypropylene materials and up to 40 to 0% by weight of a thermoplastic elastomer, respectively referring to the total weight of the respective layer, wherein following hot sterilization at 121° C. or higher temperatures using a hot water steam spraying process, the multi-layer film displays no measurable.

2. The multi-layer film according to claim 1, wherein the proportion of the total thickness of the film represented by the thickness of the middle layer (M) is in the range between 40 to 80%.

3. The multi-layer film according to claim 1, wherein the proportion of the total thickness of the film represented by the thickness of the middle layer (M) is in the range between 45 to 75%.

4. The multi-layer film according to claim 1, wherein the proportion of the total thickness of the film represented by the thickness of the middle layer (M) is in the range between 60 to 80%.

5. The multi-layer film according to claim 1, wherein the proportion of the total thickness of the film represented by the thickness of the outer layer (A) is in the range between 30 to 7.5%.

6. The multi-layer film according to claim 1, wherein the proportion of total thickness of the film which is represented by the thickness of the inner layer (I) is in the range between 30 to 12.5%.

7. The multi-layer film according to claim 1, wherein the total thickness of the film is in the range between 120 and 300 μm.

8. The multi-layer film according to claim 1, wherein the total thickness of the film is in the range between 150 and 250 μm.

9. The multi-layer film according to claim 1, wherein the total thickness of the film is in the range between 170 and 230 μm.

10. The multi-layer film according to claim 1, wherein the elasticity modulus of the material of the middle layer (M) is less than or equal to 250 MPa.

11. The multi-layer film according to claim 1, wherein the elasticity modulus of the material of the middle layer (M) is less than or equal to 150 MPa.

12. The multi-layer film according to claim 1, wherein the elasticity modulus of the material of the middle layer (M) is less than or equal 135 MPa.

13. The multi-layer film according to claim 1, wherein the elasticity modulus of the material of the middle layer (M) is less than or equal to 100 MPa.

14. The multi-layer film according to claim 1, wherein the material of the middle layer (M) has a measureable yield of less than or equal to 8 MPa.

15. The multi-layer film according to claim 1, wherein the elasticity modulus of material of the outer layer (A) is greater than 250 MPa.

16. The multi-layer film according to claim 1, wherein the elasticity modulus of material of the outer layer (A) is greater than 300 MPa.

17. The multi-layer film according to claim 1, wherein the elasticity modulus of material of the outer layer (A) is greater than 400 MPa.

18. The multi-layer film according to claim 1, wherein the melting point of the layer (A) is greater than the melting point of the layer (I), respectively, for each layer.

19. The multi-layer film according to claim 1, wherein the melting point of the layer (M) is less than the melting point of the layer (A) and greater that the melting point of the layer (I), respectively for each layer.

20. The multi-layer film according to claim 1, wherein the layers (A), (M) and (I) have Vicat temperatures which, with respect to layer (M) is in the range from 35 to 75° C., and with respect to layers (A) and (I) are in the raneg of less than or equal to 121° C.

21. The multi-layer film according to claim 1, wherein the layers (A), (M) and (I) have Vicat temperatures which, with respect to layer (M) is in the range from 35 to 70° C., and with respect to layers (A) and (I) are in the range of less than or equal to 121° C.

22. The multi-layer film according to claim 1, wherein the layers (A), (M) and (I) have Vicat temperatures which, with respect to layer (M) is in the range from 40 to 65° C., and with respect to layers (A) and (I) are in the range of less than or equal to 121° C.

23. The multi-layer film according to claim 1, wherein the layers (A), (M) comprise up to 100% by weight and the layer (I) by up to 60 to 100% by weight, of one or more polymers selected from the group consisting of homopolymers of polypropylene (homo-PP's), random copolymers of polypropylene (random co-PP's), block copolymers of polypropylene, flexible copolymers of polypropylene (co-FPO's), flexible copolymers of polypropylene (co-FPO's), and the layer (A) comprises additionally up to 40 to 0% by weight styrene-ethylene/butylene-styrene block copolymers (SEBS).

24. The multi-layer film according to claim 23, wherein the layer (I) comprises up to 70 to 90% by weight of one or more polymers from the group consisting of homopolymers of polypropylene (homo-PP's), random copolymers of polypropylene (random co-PP's), block copolymers of polypropylene, flexible copolymers of polypropylene (co-FPO's), flexible copolymers of polypropylene (co-FPO's).

25. The multi-layer film according to claim 23, wherein the layer (A) comprises additionally up to 30 to 10% by weight of styrene-ethylene/butylene-styrene block copolymers (SEBS).

26. The multi-layer film according to claim 1, comprising five layers having the sequence (A₁-M₁-A₂-M₂-I) or (A₁-M₁-M₂-A₂-I), the thickness of (M) and (A) being the sum of (Mᵢ) and (Aᵢ) respectively.

27. The multi-layer film according to claim 1, comprising seven layers in the sequence (A₁-M₁-A₂-M₂-A₃-M₃-I), the thickness of (M) and (A) being the sum of (Mᵢ) and (Aᵢ) respectively.

28. A method of producing a multi-layer film according to claim 1, comprising co-extruding the layers.

29. The method according to claim 28, wherein the film is co-extruded as a flat or tubular film.

30. A method of producing a multi-layer film according to claim 1, comprising lining the layers with one another.

31. The method according to claim 30, wherein the film is lined as a flat film.

32. A packaging comprising a multi-layer film according to claim 1.

33. The packaging according to claim 32, wherein the packaging accommodates or stores water-based parenteral fluids.

34. The packaging according to claim 32, wherein the packaging accommodates or stores fluid lipophilic emulsions.
